(19) United States
(12) Patent Application Publication
(10) Pub. No.: US 2026/0255035 A1
(43) Pub. Date: Aug. 27, 2026

(54) IMAGE SIGNAL PROCESSING TEMPERATURE CONTROL

(71) Applicant: Taiwan Semiconductor Manufacturing Company, Ltd, Hsinchu (TW)

(72) Inventors: Chien-Ming Hung, New Taipei City (TW); Kuo-Wen Kung, Hsinchu City (TW); Meng-Lin Lu, Hsinchu City (TW); Chung-Shih Chiang, Hsinchu City (TW)

(73) Assignee: Taiwan Semiconductor Manufacturing Company, Ltd, Hsinchu (TW)

(21) Appl. No.: 19/059,993

(22) Filed: Feb. 21, 2025

(51) Int. Cl. H04N 23/52

(52) U.S. Cl. CPC H04N 23/52

(57) ABSTRACT

Temperature control for an image signal processor is provided. An integrated circuit includes a plurality of photodetectors, each electrically coupled with a source follower (SF). The plurality of the SF are electrically coupled with an image signal processor (ISP). The integrated circuit includes a temperature detection circuit thermally coupled with at least one of the SF or the ISP. The integrated circuit includes control circuitry configured to activate a temperature control device (TCD) configured to heat a portion of the ISP. The engagement can be based on a temperature detected by the temperature detection circuit.

### BACKGROUND

Semiconductor devices are used in a variety of electronic applications, such as personal computers, cell phones, digital cameras, and other electronic equipment. Semiconductor devices are fabricated by sequentially depositing insulating or dielectric layers, conductive layers, and semiconductor layers of material over a substrate, and patterning the various material layers using lithography to form circuit components and elements thereon. As the semiconductor industry has progressed into nanometer technology process nodes in pursuit of higher device density, improved performance, and lower costs, challenges from both fabrication and design issues have resulted in the development of stacked substrates, such as in the case of wafer or die bonding. Accordingly, various components of a circuit may be distributed between substrates. For example, an image signal processor can be disposed over, or couple with, components of various levels of a multi-substrate stack.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a schematic of an example integrated circuit including a temperature control unit, in accordance with some embodiments.

FIG. 2 illustrates an example cross sectional view of a semiconductor device including first and second substrates, in accordance with some embodiments.

FIG. 3 illustrates a schematic of an example integrated circuit including a temperature control unit, in accordance with some embodiments.

FIG. 4 illustrates an example cross sectional view of a semiconductor device including first, second, and third substrates, in accordance with some embodiments.

FIG. 5 illustrates another example cross sectional view of a semiconductor device including first, second, and third substrates, in accordance with some embodiments.

FIG. 6 illustrates yet another example cross sectional view of a semiconductor device including first, second, and third substrates, in accordance with some embodiments.

FIG. 7 illustrates a noise performance graph for various temperatures, in accordance with some embodiments.

FIG. 8 illustrates a noise performance to temperature graph, in accordance with some embodiments.

FIG. 9 illustrates an example layout of a temperature control device, in accordance with some embodiments.

FIG. 10 illustrates an example flow chart of a method for image detection, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Generally, portions of sensors, such as an analogue-to-digital converters (ADC), can incur noise from random telegraph noise (RTN), where charge carriers are alternatively trapped and un-trapped in defects or other traps. At low temperatures, such noise may become more pronounced or evident. For example, the charge carriers may remain trapped longer or a number of traps may increase at low temperatures for some materials. Similarly, other phenomena such as flicker noise (FN) can occur with greater effect at lower temperatures. Accordingly, image signal processors (ISPs) can incur greater noise at low temperatures for at least some components (e.g., differential input amplifiers), limiting effective fidelity of images.

Further components of an imaging system can perform better at lower temperatures. For example, leakage current (and noise or other imaging error associated therewith) of a source follower (SF) can correlate positively with temperature. Accordingly, where an imaging system is cool, RTN and other effects may be more pronounced relative to the effects of SF leakage. Conversely, if the imaging system is warm, RTN and other effects may be diminished in both absolute and relative terms, while the effects of SF leakage currents and other phenomena may pose a greater concern.

In some cases, a temperature of separate portions of a semiconductor device can be managed separately, as in the case of a SF and an ADC or other portion of an ISP. In some cases, the various elements of an imaging system can be disposed across multiple wafers (e.g., bonded wafers). Further, although referred to generally, separate portions (e.g., zones including components related to one or more pixels) can maintain different temperatures. For example, a zone close to processing circuitry may be somewhat elevated in temperature, while another zone close to a thermal sink may remain somewhat cooler.

According to systems and methods of the present disclosure, a temperature of one or more zones can be managed. Each zone can include a SF, ADC, or other circuitry for one or more active pixel sensors (APS) of an imaging system. A temperature sensor can detect a temperature of one or more zones of the system. Based on the temperature, a heating element of a temperature control device can be selectively activated or deactivated. In devices including multiple zones, the temperature sensor can detect or otherwise determine (e.g., interpolate, according to a gradient) a temperature for each zone. Accordingly, one or more of various heating elements can be selectively activated or deactivated on a zone-basis, each zone including one or more APS.

In some embodiments, the temperature control device can include a resistive heater (e.g., a grided array of tungsten or other metals, silicon, or silicon carbide). In some embodiments, the temperature control device can include a thermoelectric device (sometimes referred to as a Peltier cooler). The thermoelectric device can transfer heat between a first and second surface. By placing such a device adjacent to an active surface of a substrate for the ISP, the ISP temperature can be elevated. Moreover, an opposite surface of the thermoelectric device can be cooled thereby. In some embodiments, the thermoelectric device can be placed between the active surface of the ISP and a source follower transistor. Such an implementation can simultaneously cool an SF transistor (to reduce a leakage current) and warm an ADC (to reduce RTN and related effects). For example, the thermoelectric device can be configured to transfer heat between a first substrate including the SF along a first active surface and a second substrate including the ADS along a second active surface.

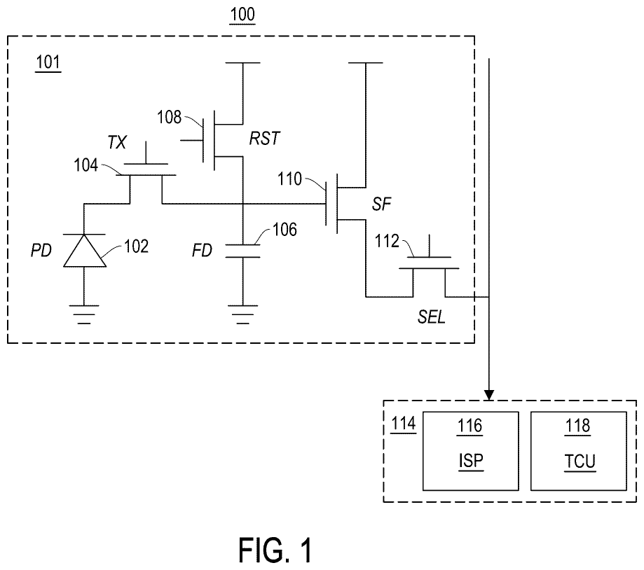

Referring now to FIG. 1, a schematic of an example integrated circuit 100 including a temperature control unit 118 is provided in accordance with some embodiments. The integrated circuit 100 includes an active pixel sensor (APS) (more particularly, a four transistor (4T) APS is depicted). The APS includes a photodetector 102, provided according to an illustrative example of a photodiode (e.g., proportional photodiode). The present disclosure further contemplates other detectors such as phototransistors, photoconductors, or avalanche photodiodes. A transfer gate (TX) 104 can gate a connection between the photodetector 102 and a floating diffusion (FD) node 106 so that the photodetector 102 can selectively charge the FD node 106 to accumulate a charge corresponding to detected radiation (e.g., photons). A source follower (SF) 110 can buffer the voltage level of the FD node 106 to provide a voltage (or current) reference to an image signal processor (ISP) 116 upon an activation of a select line 112. A reset line 108 is provided to clear the charge from the FD node 106. Although depicted according to a four-transistor (4T) APS, the present disclosure contemplates and can be used in conjunction with various APS circuits (e.g., 3T, 5T, 10T, and so on).

Various of the components of the APS can exhibit temperature-dependent performance. For example, the source follower 110 can provide a temperature dependent leakage current as may be passed onto the ISP 116 at higher temperatures, reducing visual fidelity of generated images. Further, increasing temperatures can be associated with other components such as a dark current of a photodetector. Moreover, the ISP 116 itself can exhibit temperature-dependent performance. In some cases, performance losses can relate to high temperatures, such as thermal noise or high temperature signal integrity (SI) degradation. However, at low temperatures, other phenomena such as RTN and FN, can dominate or at least contribute to performance losses. Accordingly, assuming a constant temperature for the entire integrated circuit 100, visual fidelity of generated images can be best when a contribution of error (e.g., noise or dark current) is lowest, at a temperature which is neither too low or too high. Such a temperature may be referred to as a local minimum temperature, or sometimes as an optimal temperature, where the optimal refers to an optimum associated with a local minimum that may or may not also represent a global optimum. For example, in some cases, simultaneous heating of the ISP 116 and cooling of the SF 110 can provide lower noise than the local minimum referred to above.

A temperature control unit (TCU) 118 can adjust the temperature of the integrated circuit 100, such as by cooling the integrated circuit 100 when the temperature exceeds the local minimum, or heating the integrated circuit 100 when the temperature is less than the local minimum. The TCU 118 is sometimes referred to as a temperature control circuit, without limiting effect. The TCU 118 can include a temperature sensor configured to detect a temperature associated with the integrated circuit 100. The TCU 118 can include a temperature control device (TCD) to heat or cool one or more components of the integrated circuit 100. The TCD can include, for example, a resistive element or thermoelectric device configured to transport heat between a first and second surface thereof, the first and second surfaces being thermally coupled with different components of the integrated circuit 100.

Multiple APSs (e.g., thousands, millions, or billions of instances) can be arrayed to from sensor arrays (e.g., imagers with corresponding kilo-, mega-, or gigapixel resolution). A TCU 118 can be coupled with a single APS or multiple instances of the APS. For example, a single TCU 118 instance can be provided for an entire sensor or a zone of a sensor (e.g., a spatial region of pixels or a subset of pixel types).

Each TCU 118 can include one or more temperature sensors or other sensors configured to detect a condition indicative of a noise level (e.g., current sensors or voltage sensors). In some APS arrays including multiple sensors, the TCUs 118 are configured to determine temperatures associated with individual temperature control zone, as may relate to an APS or other zone of the device according to a gradient or other function (e.g., based on a known proximity to a heat source, heat sink, or other zone). The TCU 118 can operate a TCD based on a sensed value. For example, where a temperature falls below a local minimum for visual fidelity of generated images, the TCU 118 can heat the integrated circuit 100 (or multiple instances or portions of the integrated circuit 100, as may be arrayed into a zone).

In some cases, the TCU 118 can operate based on temperatures of particular components of the integrated circuit 100. For example, the TCU 118 can selectively heat or cool one of multiple zones, or selectively heat the ISP 116. Where the TCU 118 includes a thermoelectric device, the thermoelectric device may be coupled between separate portions of the integrated circuit 100, such as between the SF 110 and the ISP 116, so that the operation of the thermoelectric device can simultaneously heat the SF 110 (as may reduce RTN or FN) and cool the SF 110 (as may lower a leakage current). Such a configuration can reduce a noise floor of an integrated circuit 100 below the local minimum described above.

In some cases, components of the integrated circuit 100 can be disposed across multiple substrates. For example, the depicted APS circuit can be disposed on a first substrate 101 with the ISP 116 disposed on a second substrate 114. At least a portion of the TCU 118, such as a temperature sensor thermally coupled with the ISP 116, can be diposed on the second substrate 114. For example, the temperature sensor can thermally couple with at least a differential amplifier or other input for an ADC or of the ISP 116.

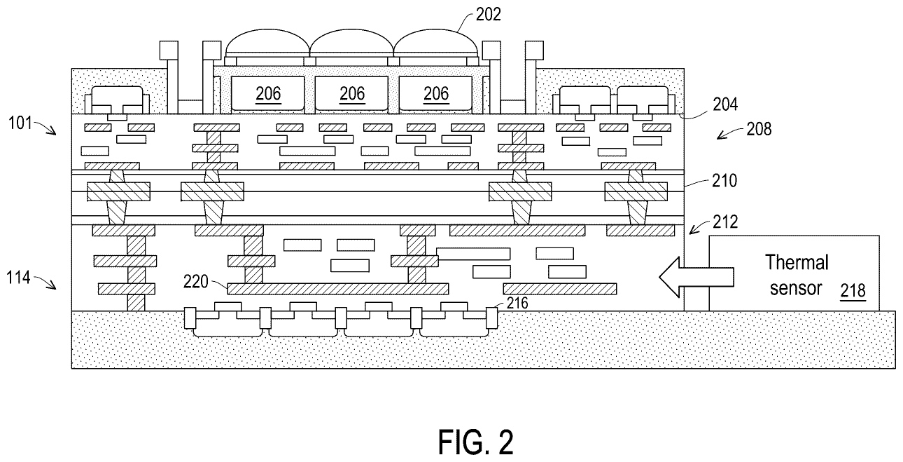

FIG. 2 illustrates an example cross sectional view of a semiconductor device 200 including a first substrate 101 and a second substrate 114, in accordance with some embodiments. The semiconductor device 200 of FIG. 2 can implement the integrated circuit 100 of FIG. 1. The semiconductor device 200 includes a first substrate 101 including APS circuit components and a second substrate including various ISP 116 and TCU 118 components. More particularly, a thermal sensor 218 and heater 220 are provided on or thermally coupled with the second substrate 114.

The first substrate 101 (e.g., semiconductive substrate such as silicon substrate) can include or interface with a stack 202 (e.g., optical stack 202) configured to selectively pass, filter, or otherwise provide incoming signals (e.g., photons) to a photodetector 102 of an active surface 204 of the first substrate 101. For example, the stack 202 can include a Bayer filter in a color image sensor implementation, such as a complementary metal-oxide-semiconductor (CMOS) image sensor (CIS). The active surface 204 can include various microelectronic devices of an integrated circuit 100, such as transistors and diodes. For example, the active surface 204 can include photodiodes 206 coupled with the optical stacks 202, and various transistors of the APS (e.g., the TX 104, RST 108, SF 110, or SEL 112 transistors of a 4T APS, as depicted in FIG. 1). In some embodiments, a charge accumulator (e.g., capacitor or charge coupled device, CCD) of the FD 106 is implemented on the active surface 204. In some embodiments, the FD 106 is implemented in metallization layers 208 formed over the active surface 204.

The first substrate 101 can be coupled with (e.g., bonded to) a second substrate 114. For example, the first substrate 101 can be coupled with the second substrate 114 in a front-to-front configuration, where the metallization layers 208 of the first substrate 101 couple with corresponding metallization layers 212 of the second substrate 114 at a junction 210. The metallization layers 208, 212 can include electrical, thermal, or other connections across the junction 210. The second substrate 114 includes an active surface 216 to implement the ISP 116, and, in some cases, components of the TCU 118. The second substrate 114 further includes a sensor indicative of a noise level, such as the depicted thermal sensor 218 which may be provided as integral to or otherwise thermally coupled with the active surface 216 of the second substrate 114. Accordingly, the thermal sensor 218 is thermally coupled with the ISP 116.

The second substrate 114 further includes a temperature control device (e.g., a heater 220) configured to heat the active surface 216 of the second substrate 114, as may reduce RTN and FN related noise. As is depicted, the heater 220 can be implemented as a resistive heater 220. Such an implementation can include tungsten heating elements arranged in a grid to heat portions of the ISP 116. In some embodiments, either of the metallization layers 208, 212 can include an RDL or other layer which exhibits greater thermal mass and lower resistance than any other of the metallization layers. Such a layer can be disposed proximal to the junction, in some embodiments. Accordingly, heat generated by the heater 220 may thermally coupled with the RDL so as to not substantially contribute to heating of the first substrate 101 (e.g., an active surface 204 thereof). In some embodiments, metallic connectors or other thermally conductive portions are routed away from a lateral area between the heater 220 and the photodiodes 206 to reduce a thermal coupling therebetween. The TCU 118 can operate the heater 220 based on temperatures (or other indications of noise) detected by a sensor. Such an approach can avoid heating the ISP 116 above the local minimum for noise.

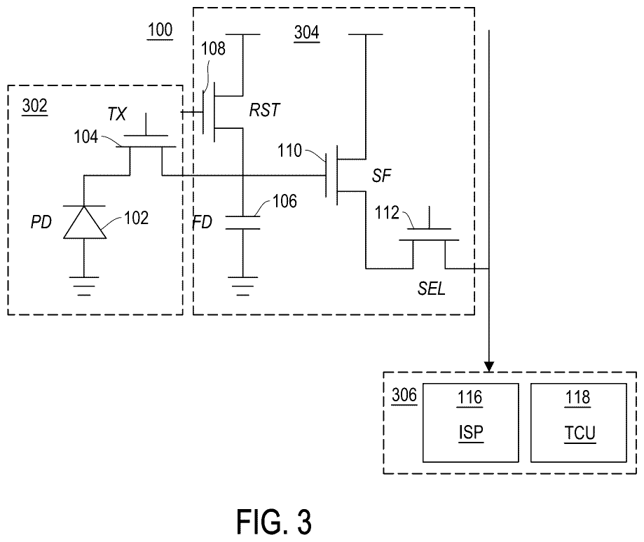

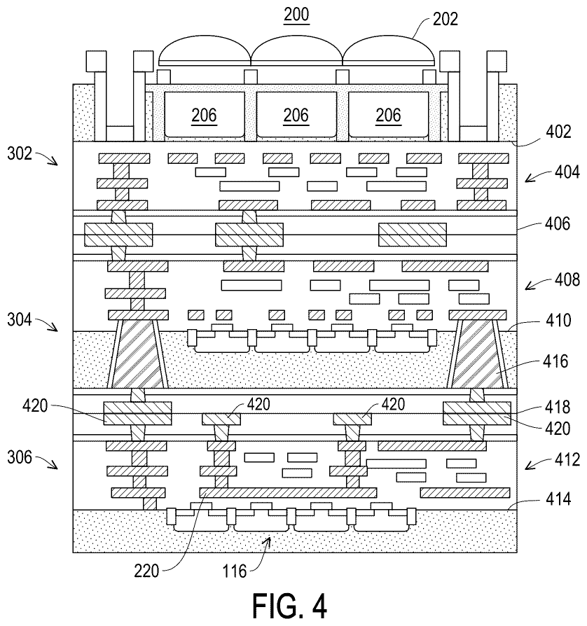

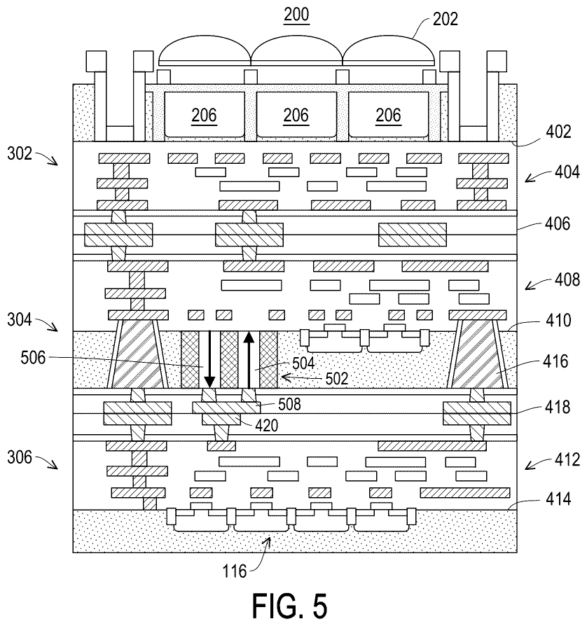

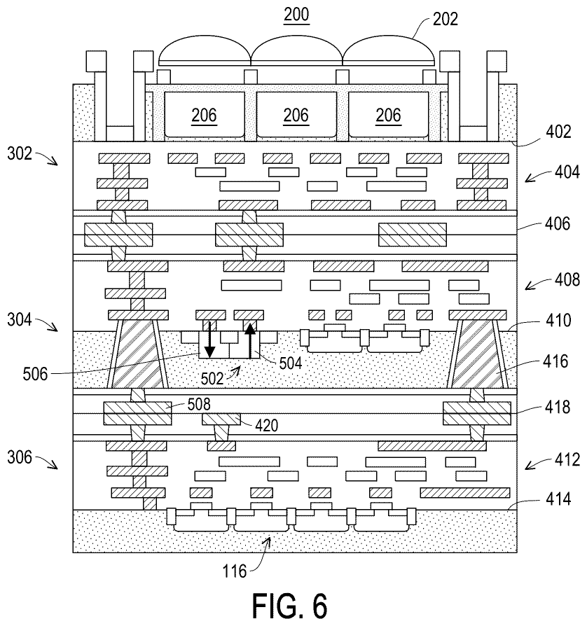

FIG. 3 illustrates a schematic of another example integrated circuit 100 including a temperature control unit 118, in accordance with some embodiments. The depicted integrated circuit 100 includes a photodiode 206 and TX gate 104 as depicted in FIG. 1. Such components are depicted as disposed on a first substrate 302, with other components of the APS circuit depicted on a second substrate 304 coupled therewith (e.g., bonded to). The separation of the components between substrates can aid to increase lateral density of the device (e.g., a number of pixels per unit area). Moreover, the separation of components between substrates can aid to thermally insulate various components from one-another. As depicted in FIG. 1, a further substrate (provided as a third substrate 306 of the present integrated circuit 100) can include at least some portions of an ISP 116, as may be coupled with a TCU 118. The TCU 118, in turn, can monitor and adjust temperature-dependent operation of various components of the integrated circuit 100. Some example semiconductor devices 200 implementing the integrated circuit are provided henceforth in each of FIG. 4, FIG. 5, and FIG. 6.

Referring to FIG. 4, FIG. 5, and FIG. 6 generally, example cross sectional views of a semiconductor device 200 including a first substrate 302, second substrate 304, and third substrate 306 are provided. The semiconductor device 200 includes the first substrate 302 having an optical stack 202 configured to provide incoming photons to a detector (a photodiode 206). The optical stack 202 is illustrated as optically coupled with a photodiode 206 detector along an active surface 402 of the first substrate 302, as in FIG. 2. Such an illustrative example should not be construed as limiting. Various detector architectures may be substituted for the depicted example.

Metallization layers 404 formed over the active surface 402 of the first substrate 302 electrically connect the photodiodes 206 to terminals coupled with corresponding terminals of second metallization layers 408 of a second substrate 304 across a first interface 406. The second metallization layers 408 are formed over a second active surface 410 as may include various components of the APS, as are depicted in FIG. 3. More particularly, such components include a reset line 108, FD node 106 charge accumulator, SF 110, and select line 112 in a 4T configuration, and can include additional or fewer components in various further embodiments.

As is depicted, the first substrate 302 and second substrate 304 are coupled in a front-to-front configuration. Such an implementation can reduce a length, resistance, parasitic capacitance, and otherwise improve SI for electrical communication between the photodetectors 102 of the first substrate 302 and a buffer (e.g., SF 110) of the second substrate 304. Moreover, the front-to-front configuration can lower thermal resistance between the active components of the second substrate 304 and the surface of the first substrate 302, relative to a back-to-back or front-to-back configuration. Accordingly, both SI and thermal sinking may be improved, relative to some alternative approaches.

The second substrate 304 is coupled with a third substrate 306 including an ISP 116 implemented via various components of an active surface 414 thereof. For example, the components can include an analog to digital converter (ADC) configured to compare an analog level of a voltage or current, as amplified by the SF 110 and conveyed according to an actuation of the select line 112 (as may be controlled by the ISP 116). Even more particularly, a differential amplifier of the ADC may be configured to receive input from the second substrate 304 in some embodiments.

The coupling between the second substrate 304 and the third substrate 306 includes terminals, depicted as backside through-silicon vias (TSVs) 416, coupling interface terminals of the second substrate 304 with corresponding interface terminals 420 of the third substrate 306 across a second interface 418. The terminals 420 of the third substrate 306 are provided as formed at or over a top metallization layer of third metallization layers 412 of the third substrate 306. That is, the third substrate 306 and the second substrate 304 are coupled according to a front-to-back configuration. Such an implementation can provide increased thermal isolation between the respective substrates 304, 306, relative to a front-to-front configuration. Moreover, parasitic capacitance and resistive losses associated with such a configuration may be lower than in a back-to-back configuration (which may exhibit increased thermal insulation between the second substrate 304 and third substrate 306).

The third substrate 306 can further couple with or include at least a portion of a TCU 118. For example, the third substrate 306 can include a sensor indicative of a noise level, such as a thermal sensor 218, as was depicted in FIG. 2. This sensor may be referred to as a temperature detection circuit, where the sensor detects a noise or other error source which corresponds to a temperature value. Such a circuit may be implemented according to various techniques, such as those based on relationships between temperature and a band gap voltage of a semiconductor, a leakage current, silicon resistivity, or so forth. The sensor is omitted from FIGS. 4-6 to aid in the clarity of the depiction of the other components, such as the various implementation of the TCD of the TCU 118. The various TCD implementations are provided henceforth, with more particular reference to corresponding figures.

Referring particularly to FIG. 4, an example cross sectional view of a semiconductor device 200 including a resistive heater 220 is provided. The heater 220 is thermally coupled with components of an ISP 116 implemented on the active surface 414 of the third substrate 306 (e.g., with an ADC of the ISP 116). The heater 220 can include resistive elements formed over at least a portion of the ISP 116 to regulate a temperature of the ISP 116. For example, a heating element of the heater 220 can include tungsten elements arranged in a grid to heat a portion of the ISP 116. In some embodiments, the heater 220 includes separately engageable elements for separate temperature control zones. For example, the heater 220 can be provided and thermally coupled on a per-APS temperature control zone, as may refer to any portion of an APS, such as an SF 110. In some embodiments, the heater 220 is provided and thermally coupled on a per-multi-APS zone basis (e.g., one engageable element per multi-APS zone), or a per-ISP basis (e.g., one engageable element per multi-APS zone).

The heater 220 of the TCU 118 is operatively coupled with a temperature detection circuit of the TCU 118. The temperature detection circuit can be thermally coupled with at least one of the ISP 116 or the SF 110. In some embodiments, separate detectors of the temperature detection circuit can be provided for the ISP 116 and SF 110, respectively. Like the heating elements, the temperature detection circuits may be implemented on a per-SF 110, per-zone, per-ISP 116, or another basis. Any of the heating elements may be combined with any of the temperature detection circuits according to various implementations of the present disclosure. For example, temperature may be sensed on a per-SF 110 basis and a heater can be configured to operate on a per-ISP basis (e.g., based on an average, maximum, or minimum temperature). In another example, temperature may be sensed on a per-zone basis and a heater can be configured to operate on another basis (e.g., using interpolated gradients between zone-detected temperatures). Control circuity of the TCU 118 can operatively couple a temperature detection circuit with a corresponding heating element of the heater 220. The control circuity can include a controller configured to execute instructions, or hardwired circuitry. For example, the control circuity can include analog or other discrete implementations such as controlling a current passed through the heating elements based on a temperature-dependent resistance of a silicon resistor or diode.

Although heating the ISP 116 of the third substrate 306 can realize benefits related to, for example, RTN and FN, such heat can negatively impact certain circuits disposed on the second substrate 304, such as a leakage current across the SF 110, or the first substrate 302, such as a dark current of the photodiodes 206. Accordingly, as is depicted, thermally conductive elements disposed over the heater 220 can be omitted, or an RDL can be provided to thermally sink excess heat away from the second substrate 304. Such implementations can, at least somewhat, thermally decouple the heater 220 from the active surface 410 of the second substrate 304. Accordingly, any temperature impact of the heater 220 on other components of the APS (e.g., the SF 110) can be mitigated, relative to other approaches.

Referring particularly to FIG. 5, an example cross sectional view of a semiconductor device 200 including a thermoelectric device 502 is provided. The thermoelectric device 502 is thermally coupled with components of an ISP 116 implemented on the active surface 414 of the third substrate 306. As in FIG. 4, a heater 220 is provided as thermally coupled with the ISP 116 and configured to heat the ISP 116 upon a detection of a condition indicative of noise or other error (e.g., low temperatures). The present heater 220 is implemented as a part of a thermoelectric device 502. The thermoelectric device 502 is a solid-state system that uses electrical energy to create a temperature difference (the Peltier effect). More particularly, the depicted thermoelectric device 502 is formed by laterally separated N-type wells (n-wells) 504 and P-type wells (p-wells) 506. As depicted, the thermoelectric device 502 can include a heater 220 at a bottom surface and a cooler at a top surface.

The thermoelectric devices 502 pass an electrical current through the junctions between these regions to create a temperature gradient due to the Peltier effect, with one side of the device being heated while the other is cooled. In the present example, the opposite, “cooled” side of the thermoelectric device 502 is thermally coupled with other components of the APS, such as the SF 110 of the second substrate 304. Accordingly, the operation of the thermoelectric devices 502 can simultaneously heat an ADC or other portion of an ISP 116, and cool other components of the semiconductor device 200. Such operation can improve noise behavior of the semiconductor device. In some cases, such improvement can exceed a local minimum of an optimal homogeneous temperature of the semiconductor device 200 where the SF 110 and ISP 116 are disposed at a same “optimal” temperature. In some embodiments, the TCU 118 is configured to operate the thermoelectric devices 502 in reverse, by inverting a polarity of voltages connected thereto. Such an approach can provide cooling to an IPS, in devices for which a corresponding increase in noise from the heat provided to the SF 110 is less than the benefit from cooling the ADC. Moreover, by alternatively reversing polarity, the thermoelectric device 502 can heat both sides, according to thermal transfer inefficiencies of the thermoelectric devices 502.

The thermoelectric device 502 can operate based on a current received from either of the second substrate 304 or the third substrate 306. Moreover, the second substrate 304 and third substrate 306 can include thermally conductive elements between the thermoelectric device 502 and the active surface 414 of the third substrate. For example, as depicted, the thermally conductive elements can be provided as electrically conductive elements to supply a voltage across the thermoelectric device 502 (e.g., metal lines of the metallization layers or other terminals 420 of the third substrate 306 and corresponding terminals 508 of the second substrate 304). Providing electrical current to the thermoelectric device 502 from the third substrate 306 co-locates resistive or other thermal losses associated with such current at a same location as the heat output, rather than heating a SF 110 or other components of the second substrate 304. However, extending an active surface 410 to a backside of the second substrate 304 can be associated with its own challenges. For example, such an extension can include patterning both sides of the substrate 304, thinning a wafer sufficient to form the doped wells from a same side of a wafer, or so on. Accordingly, in some embodiments, the thermoelectric device 502 can operate as electrically coupled with the second substrate 304, with n-wells 504 and p-wells 506 which do not extend to the backside of the second substrate 304.

Referring particularly to FIG. 6, an example cross sectional view of a semiconductor device 200 including a thermoelectric device 502 is provided. The thermoelectric device 502 is thermally coupled with components of an ISP 116 implemented on the active surface 414 of the third substrate 306. The n-wells 504 and p-wells 506 are electrically coupled with the metallization layers 408 of the second substrate 304, and do not extend to the backside of the second substrate 304. Such an implementation can reduce a size of a P-N junction (between the n-wells 504 and p-wells 506). Further, a thermal coupling between the ISP 116 and the thermoelectric device 502 can be somewhat reduced, relative to some implementations of FIG. 5. For example, where the terminals 420, 508 are provided as copper interconnects, the substitution of copper for a silicon wafer can correspond to an increase a thermal resistance. However, the silicon wafer can provide adequate thermal conductivity to heat the active surface 414 of the third substrate 306. Moreover, any incident heat returned, through the base material of the silicon or other substrate, to the SF 110 or other components of the APS may be partially offset, totally offset, or surpassed by a cooling effect of a cooling surface of the thermoelectric device 502 opposite from the heating surface of the heater 220.

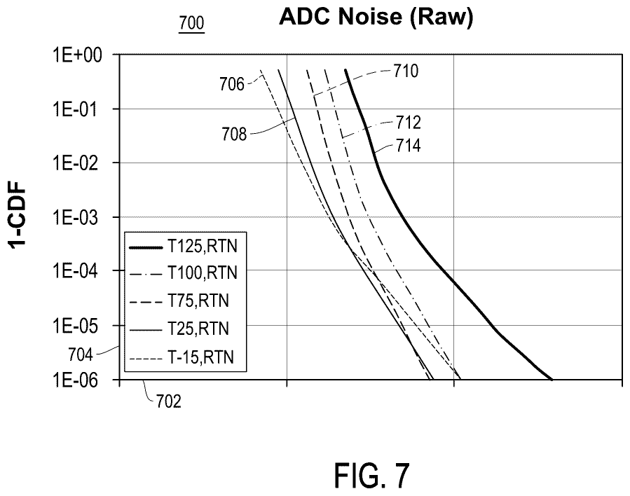

FIG. 7 illustrates a noise performance graph 700 for various temperatures, in accordance with some embodiments. A first axis 702 provides an indication of a noise level (e.g., microvolts roots-mean-squared). Rightmost portions of the axis 702 correspond to higher noise levels while leftmost portions of the axis 702 correspond to lower noise levels. A second axis 704 provides a noise distribution spread, and more particularly, a complementary cumulative distribution function, with values indicating the probability that the noise level exceeds a given threshold on the first axis 702.

The curves each correspond to a different temperature. More particularly, a first curve 706 corresponds to a temperature of about negative fifteen degrees Celsius, a second curve 708 corresponds to a temperature of about twenty-five degrees Celsius, a third curve 710 corresponds to a temperature of about seventy-five degrees Celsius, a fourth curve 712 corresponds to a temperature of about one-hundred degrees Celsius, and a fifth curve 714 corresponds to a temperature of about one-hundred-twenty-five degrees Celsius. As can be viewed from the top of the graph 700, a noise level floor can correspond to an absence of RTN, FN, or other phenomena, wherein the noise floor corresponds inversely to temperature based on dark current variation, SF leakage current, or other circuit behavior. However, upon occurrence of certain phenomena, such as RTN or FN, a noise of lower-temperature devices can exceed their higher temperature counterparts.

Specific values are provided herein, as corresponding to behavior characteristics of an illustrative example of the present disclosure. However, such values can vary according to various implementations of semiconductor devices 200 contemplated in the present disclosure. Accordingly, in some cases, noise behavior can present or reach a local minimum at higher or lower temperatures.

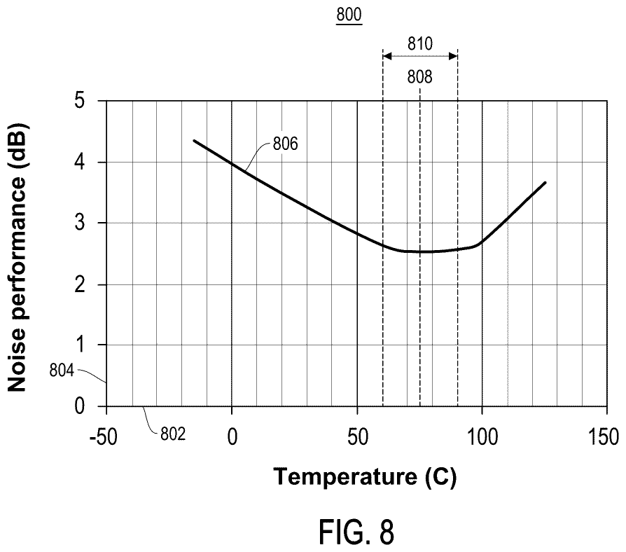

FIG. 8 illustrates a noise performance to temperature graph 800, in accordance with some embodiments. A first axis 802 provides an indication of a temperature. More particularly, the temperature is provided as a temperature of an ADC portion of the ISP 116. A second axis 804 provides a noise level in decibels. The curve 806 depicts performance over temperature. The curve 806 is normalized to a part per million (PPM) value of the complementary cumulative distribution function (e.g., one PPM, two PPM, or so on).

Lower temperature performance and higher temperature performance exhibits greater noise relative to a local minimum 808 disposed within an operation window 810 of the TCU 118. In some embodiments, an operation window 810 spans from about sixty degrees Celsius to about seventy-five degrees Celsius or about fifty degrees Celsius to about seventy degrees Celsius, though such a range can vary according to various implementations. For example, the depicted operation window 810 spans from about sixty degrees Celsius to about ninety degrees Celsius. In some embodiments, the local minimum 808 is the upper bound of the operation window 810, such that a heater 220 is not activated to heat an ISP 116 already at a temperature exceeding the local minimum 808.

In response to a detection of an ISP temperature of less than the lower bound of an operating window 810, the TCU 118 can activate a heater 220 thermally coupled with at least a portion of the ISP 116. In some embodiments, the heater 220 is a resistive heater 220. In some embodiments, the heater 220 is a surface of a thermoelectric device 502 opposite from a cooler, such that cooling can be provided to another component of the semiconductor device 200. In some embodiments, the TCU 118 can selectively activate either of a resistive heater 220 or a thermoelectric device 502 based on various temperatures. For example, the TCU 118 can cool responsive to a temperature exceeding a temperature threshold of less than seventy-five degrees Celsius, and cool responsive to a temperature less than a temperature threshold of fifty degrees Celsius or greater.

In some embodiments, the local minimum 808 is not the upper bound of the operation window 810. For example, the TCU 118 can be configured to activate the heater 220 to heat the ISP 116 to a temperature above the local minimum 808. Although noise associated with the ISP 116 may increase somewhat, an overall noise may be decreased, corresponding to a lowered temperature of the SF 110 or other components of the APS. In some embodiments, the TCU 118 is configured to activate a thermoelectric device 502 based at least in part on a detected temperature exceeding a predefined temperature threshold.

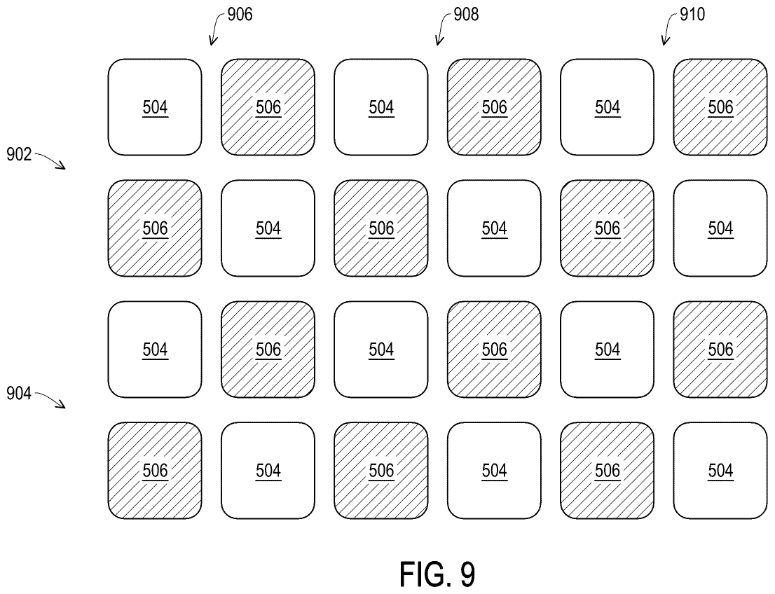

FIG. 9 illustrates an example layout of a TCD, in accordance with some embodiments. The TCD includes a junction between two materials having different Seebeck coefficients, as may be exploited to realize the Peltier effect. More particularly, the depicted example includes paired n-wells 504 and p-wells 506. Each of the pairs can be referred to as engageable elements. Further, in embodiments using resistive heaters 220, each individually actuated portion may be referred to as an engageable element (e.g., a portion of a tungsten containing resistive grid). Each of the engageable elements can be thermally coupled with at least a portion of an ISP 116. As is further depicted, the engageable elements can be arrayed into rows and columns for temperature control zones for an APS (e.g., a SF 110). For example, a first row 902 and second row 904 can each spatially correspond to one or more rows of photodiodes 206 or other photodetectors having a SF 110, while each of a first column 906, second column 908, and third column 910 can spatially correspond to at least one column of the photodetectors having an SF 110. The depicted engageable elements can operate as thermoelectric devices 502 to heat a differential amplifier of the ISP 116 for an APS or other zone and cool an SF 110 for that APS or other zone.

In some embodiments, each of the engageable elements is configured to operate based on a temperature detected locally for a zone. In some embodiments, a controller is operatively coupled with multiple of the pairs to control temperature adjustments across a semiconductor device 200. For example, the controller can determine temperature adjustments based on thermal coupling with adjacent or zones. In some embodiments, another TCD is provide in addition to or instead of thermoelectric devices 502. For example, a conductive grid (e.g., a tungsten grid) can provide the heat to one or more zones of the ISP 116.

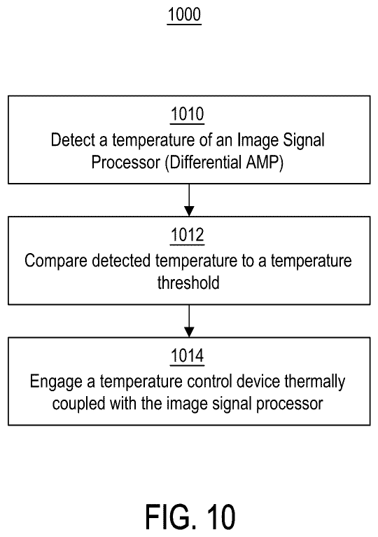

FIG. 10 illustrates an example flow chart of a method 1000 for image detection, in accordance with some embodiments. Some operations may only be described briefly herein. However, one skilled in the art will understand that the disclosed operations may be performed in conjunction with other disclosed methods disclosed herein, or generally known in the art. Further, the order of the disclosed operations is not intended to be limiting. Certain operations may be performed in a different sequence, and still further operations may be sequenced with appropriate modifications thereto. Moreover, one or more instances of the method 1000 may be performed for various APS or zones of a semiconductor device 200 (e.g., simultaneously).

At operation 1010, the method 1000 includes detecting an indication of a noise level for an image signal processor (ISP) of a semiconductor device. For example, the indication of a noise level can include a temperature detected by a temperature sensor thermally coupled with the ISP 116.

At operation 1020, the method 1000 includes comparing the indication of the noise level to a threshold value. For example, where the indication is or corresponds to a temperature, the threshold value can refer to a predefined threshold temperature. In some embodiments, the TCD is configured to heat the ISP 116 responsive to a determination that the temperature exceeds the predefined threshold temperature. This and other determinations and comparisons of the present disclosure can be performed via either of hardwired circuitry (e.g., an analog circuit implementing temperature feedback) or a controller configured to execute instructions. In some embodiments, the TCD is configured to heat the ISP 116 responsive to a determination that the indication of the noise level does not exceed the threshold value (e.g., is below an operating window 810). The TCD can be further configured to cool the semiconductor device 200 (e.g., an SF 110 thereof) responsive to a determination that the indication of the noise level exceeds a second threshold value, greater than the other threshold value. Such an implementation can lower overall noise levels, even if some component of the noise increases.

At operation 1030, the method 1000 includes activating a temperature control device (TCD) to adjust a temperature of the ISP 116 based on the comparison. The TCD can be configured to transport heat between surfaces, as in the case of a thermoelectric device 502. For example, the TCD can be configured to transport heat from a source follower (SF) 110 to the ISP 116, wherein the ISP 116 is disposed on a first substrate and the SF is disposed on a second substrate bonded to the first substrate. In addition to or instead of a thermoelectric device 502, the TCD can include a resistive heater 220. For example, the heater 220 can include various engageable elements, each of the engageable elements thermally coupled to a portion of the ISP corresponding to an APS. The method can include determining temperature data corresponding to multiple of the APS (e.g., at least one APS in each of multiple zones). The TCU 118 can engage, based on the temperature data, a first subset of the engageable elements while a second subset of the engageable elements are not engaged. Accordingly, the TCU 118 can selectively heat various APS or zones of a semiconductor device 200. The engageable elements can be or include tungsten elements arranged in a patterned grid of a same substrate as the ISP 116, in the metallization layers thereof.

The operations provided herein are not intended to limit the present disclosure. For example, operations or suboperations can be added, substituted, omitted, or otherwise modified. For example, in some embodiments, the method 1000 includes detecting various further indications of noise levels for other further portions (e.g., APS or other zones of a CMOS image sensor) of the ISP 116 of the semiconductor device 200. The further indications can also be compared to the threshold value of operation 1020. At operation 1030, further TCDs can be engaged to adjust further temperatures of the further portions of the ISP (e.g., APS or other zones of a CMOS image sensor). That is, temperature control can be provided on a per-APS or per-zone basis. In some implementations, at least one of the further TCDs is configured to cool the ISP simultaneously to the TCD heating the ISP 116 (e.g., using a thermoelectric device 502). Further, the TCD can be implemented to heat some APS or zones and cool others.

In one aspect of the present disclosure, an integrated circuit includes a plurality of photodetectors, each electrically coupled with a source follower (SF). The plurality of the SF are electrically coupled with an image signal processor (ISP). The integrated circuit further includes a temperature detection circuit thermally coupled with at least one of the SF or the ISP. The integrated circuit further includes control circuitry configured to, based on a temperature detected by the temperature detection circuit, activate a temperature control device (TCD) configured to heat a portion of the ISP.

In another aspect of the present disclosure, a semiconductor device is provided. The semiconductor device includes a temperature detection circuit configured to detect a temperature of a plurality of zones of an image signal processor (ISP), each of the zones corresponding to one or more APS. The semiconductor device includes a temperature control device (TCD) configured to adjust a temperature of the plurality of zones based on a comparison to one or more threshold values. The plurality of zones are disposed on a first substrate. The first substrate is bonded with a second substrate including a source follower (SF) transistor.

In another aspect of the present disclosure, a method of image detection is provided. The method includes detecting an indication of a noise level for an image signal processor (ISP) of a semiconductor device. The method includes comparing the indication to a threshold value. The method includes activating a temperature control device (TCD) to adjust a temperature of the ISP based on the comparison.

As used herein, the terms “about” and “approximately” generally indicates the value of a given quantity that can vary based on a particular technology node associated with the subject semiconductor device. Based on the particular technology node, the term “about” can indicate a value of a given quantity that varies within, for example, 10-30% of the value (e.g., +10%, ±20%, or ±30% of the value).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An integrated circuit, comprising:
a plurality of photodetectors, each of the plurality of photodetectors electrically coupled with a corresponding of a plurality of source followers (SFs), the plurality of SFs electrically coupled with an image signal processor (ISP);
a temperature detection circuit thermally coupled with at least one of the SFs or the ISP; and
control circuitry configured to, based on a temperature detected by the temperature detection circuit, activate a temperature control device (TCD) configured to heat a portion of the ISP.

2. The integrated circuit of claim 1, wherein the TCD is a thermoelectric device further configured to cool one or more of the plurality of SFs.

3. The integrated circuit of claim 1, wherein the TCD is further configured to:
cool the portion of the ISP, responsive to detecting that a temperature of the ISP exceeds a first temperature threshold; and
detect that the temperature is less than a second temperature threshold, wherein the heating of the portion of the ISP is responsive to the detection.

4. The integrated circuit of claim 3, wherein the first temperature threshold is about seventy-five degrees Celsius and the second temperature threshold is about sixty degrees Celsius.

5. The integrated circuit of claim 1, wherein the TCD is a resistive heater comprising tungsten elements arranged in a grid to heat the portion of the ISP.

6. The integrated circuit of claim 1, wherein:
the temperature detection circuit is configured to detect a plurality of temperatures, each of the plurality of temperatures corresponding to one or more temperature control zones; and
the TCD comprises a plurality of engageable elements configured to heat a plural number of the portion of the ISP corresponding to the one or more temperature control zones, respectively.

7. The integrated circuit of claim 1, wherein:
the plurality of photodetectors comprise a photodiode disposed on a first substrate; and
the ISP is disposed on a second substrate.

8. The integrated circuit of claim 7, wherein:
the first substrate is coupled with the second substrate in a front-to-front configuration; and
the temperature detection circuit comprises a sensor of the first substrate.

9. The integrated circuit of claim 7, wherein the plurality of SFs are disposed on a third substrate separating the first substrate from the second substrate.

10. The integrated circuit of claim 9, wherein:
the first substrate and the third substrate are coupled in a front-to-front configuration; and
the second substrate and the third substrate comprise a temperature sensor of the temperature detection circuit, and are coupled in a front-to-back configuration.

11. A semiconductor device comprising:
a temperature detection circuit configured to detect a temperature of a plurality of zones of an image signal processor (ISP), each of the zones corresponding to one or more source follower (SF) transistors of an APS; and
a temperature control device (TCD) configured to adjust a temperature of the plurality of zones based on a comparison to one or more threshold values,
wherein the plurality of zones are disposed on a first substrate, the first substrate being bonded with a second substrate comprising the source follower (SF) transistors.

12. A method of image detection comprising, comprising:
detecting an indication of a noise level for an image signal processor (ISP) of a semiconductor device;
comparing the indication to a threshold value; and
activating a temperature control device (TCD) to adjust a temperature of the ISP based on the comparison.

13. The method of claim 12, wherein:
the indication of the noise level is a temperature detected by a temperature sensor thermally coupled with the ISP; and
the threshold value is a predefined threshold temperature.

14. The method of claim 13, wherein:
the TCD is configured to heat the ISP responsive to a determination that the temperature exceeds the predefined threshold temperature.

15. The method of claim 12, wherein the TCD is a thermoelectric device configured to:
heat the ISP responsive to a determination that the indication of the noise level does not exceed the threshold value; and
cool the semiconductor device responsive to a determination that the indication of the noise level exceeds a second threshold value, greater than the threshold value.

16. The method of claim 15, wherein the TCD is configured to transport heat from a source follower (SF) to the ISP, wherein the ISP is disposed on a first substrate and the SF is disposed on a second substrate bonded to the first substrate.

17. The method of claim 12, further comprising:
detecting a plurality of further indications of noise levels for a plurality of further portions of the ISP of the semiconductor device;
comparing the plurality of further indications to the threshold value; and
activating a plurality of further TCDs to adjust further temperatures of the plurality of further portions of the ISP, wherein at least one of the further TCDs is configured to cool the ISP simultaneously to the TCD heating the ISP.

18. The method of claim 17, wherein:
the indication corresponds to a first APS of a complementary metal-oxide-semiconductor image sensor (CIS); and
the plurality of further indications corresponds to a plurality of further APS of the CIS.

19. The method of claim 12, wherein the TCD is a resistive heater comprising a plurality of engageable elements, each of the engageable elements thermally coupled to a portion of the ISP and further comprising:
determining temperature data corresponding to the portions of the ISP; and
engaging, based on the temperature data, a first subset of the engageable elements while a second subset of the engageable elements are not engaged.

20. The method of claim 19, wherein the engageable elements are tungsten elements arranged in a patterned grid of a same substrate as the ISP.
